(19) United States
(12) Patent Application Publication
(10) Pub. No.: US 2018/0086988 A1
(43) Pub. Date: Mar. 29, 2018

(54) IMPROVED METHOD FOR THE REDUCTION IN ACIDITY IN CRUDE OILS WITH A HIGH NAPHTHENIC ACID CONTENT BY MEANS OF CATALYTIC HYDROGENATION

(71) Applicant: ECOPETROL S.A., Piedecuesta (CO)

(72) Inventors: Haydee QUIROGA, Piedecuesta (CO); Laura GARZÓN, Piedecuesta (CO); Luis Oswaldo ALMANZA RUBIO, Piedecuesta (CO); Luis Javier HOYOS MARÍN, Piedecuesta (CO)

(21) Appl. No.: 15/563,400

(22) PCT Filed: Mar. 31, 2016
(86) PCT No.: PCT/IB2016/051811

§ 371 Date: Sep. 29, 2017

(30) Foreign Application Priority Data
Mar. 31, 2015 (CO) 15073602

(51) Int. Cl. C10G 45/04; C10G 45/08; B01J 23/881; B01J 23/28; B01J 23/02

(52) U.S. Cl. CPC C10G 45/04; C10G 45/08; B01J 23/881; C10G 2300/308; B01J 23/02; C10G 2300/203; B01J 23/28

(57) ABSTRACT

Naphthenic acids in crude oil are carboxylic acids characterized by one or more aliphatic or naphthenic rings having an alkyl group with a carboxylic acid group. The naphthenic acids produce atypical corrosion phenomena, given that they can cause a localized attack without the presence of water at 473-693 K, hindering the processing of such crude oils in refineries. Disclosed is a catalytic hydrogenation process that permits selective removal of naphthenic acids from heavy and extra heavy crude oils with a low production of hydrogen sulphides. The catalyst is formed by an aluminium and/or magnesium-aluminium spinel-type support having active Fe—Mo phases. The hydrogenation process using Fe and/or Mo catalysts surprisingly permits an acid number of 1 mg KOH/g to be reached in crude oils with TAN greater than 4 g KOH/g, reducing unwanted reactions and prolonging the life of the cataly

### 1. TECHNOLOGY FIELD

This invention details an enhanced process that allows the selective removal of naphthenic acids from heavy and extra heavy crudes through catalytic hydrogenation, specifically crudes with a high TAN (Total Acid Number).

### 2. STATUS OF THE TECHNIC

Currently, given the increased demand for crudes worldwide, it is necessary to use acid crudes as feeds to refineries. As it is well known, problems derived from the use of this type of crude involves fouling and corrosion given its high acidity, which is mainly connected to the naphthenic acids content in the same.

There are several reports on the status of the technique that mention the removal of naphthenic acids through catalytic hydrogenation processes. An example is patent EP0778873B1 that describes a removal process using NiMo/AL₂O₃ commercial catalysts at temperature conditions between 273 K-573 K, pressure conditions between 100 kPa-5000 kPa and at space velocity of 0.5-5 h⁻¹, catalyst of 10 to 12 nanometers porosity, reaching an acidity reduction of 96% with 2.6 TAN crudes.

A similar approach is presented by U.S. Pat. No. 5,897,769 and U.S. Pat. No. 5,910,242, which describe a process through which reduction of TAN is achieved by using hydrogenation of acidic crudes and hydro treatment commercial catalysts such as NiMo or CoMo supported on alumina or on a mixture of alumina and silica. Hydro deoxygenation is performed at temperatures between 473 K and 643 K, pressures in the range from 0 to 13 MPa and LHSV (space velocity) between 0.1 and 1 h−1. In U.S. Pat. No. 5,897,769 the invention is given by the selectivity of the removal of naphthenic acids with small molecular weight, for which a catalyst with a pore diameter between 50 and 85 Å for removing acids with molecular weight below 450 (g/mol) is used. On the other hand, invention U.S. Pat. No. 5,910,242 sets forth a hydro treatment process by adding H₂S to hydrogen to improve the reduction of naphthenic acids; such process requires gas purification plants to remove H₂S.

Other patents, such as US20070000810/2007, describe an acidity reduction process by being exposed to one or two hydrogenation catalysts composed of one or more metals from columns 6 to 19 of the periodic table to obtain a 90% acidity removal at temperature conditions of at least 623.15 K, pressures of 3.5 MPa and LHSV of 0.1 h−1

Patent CN101230289 describes a hydro treatment process for removal of naphthenic acids by using NiMo commercial catalysts with the presence of textural promoters such as MgO at concentrations between 0.3-3.5%, thus allowing to improve the activity of the catalyst to obtain acid numbers of 1 mg KOH/g in crudes with an acidity of 3.5 mg KOH/g.

Although many efforts have been made to implement more efficient processes for the removal of acidity in heavy and extra heavy crudes, the status of the technical requires new economic processes to make the technology feasible and to implement it in production fields by having selective catalysts that will result in the elimination of some stages when processing sulfur, greater times of useful life of the catalyst and the reduction in consumption of hydrogen in the process.

### 3. GENERAL DESCRIPTION OF THE PROCESS

This invention describes a catalytic hydrogenation process that allows the selective removal of naphthenic acids in heavy and extra heavy crudes with a low production of hydrogen sulfides, specifically in crude not previously distilled into fractions. The catalyst is composed of an alumina type support and/or magnesium aluminum spinel with Fe—Mo active phases. In addition, it has been surprisingly found that the hydrogenation process using Fe and Mo and/or their mixtures allows to obtain acid numbers of 1 mg KOH/g or lower in crudes with acidity greater than 4 mg KOH/g, allowing for the reduction of unwanted reactions in the process and extending the useful life of the catalyst as a result of the low deposition of metal sulphides.

### 4. DETAILED DESCRIPTION OF THE PROCESS

FIG. 1 shows the process designed to achieve the reduction of naphthenic acids; the process begins in a crude storage tank in production fields (1), crude is pumped by a pump (2) through the line (101) to the mixer (3), where crude is combined with fresh hydrogen and recirculating hydrogen from the line (102) and (110), respectively. The mixture is then driven to the furnace (5) from where the preheated mixture leaves through line (104) to the catalytic hydrogenation reactor (6). Reaction products are carried through line (105) to a phase separator (7), from where gases are treated in the amine plant (8); sour waters (A) are driven to treatment system and liquid fraction is sent through the line (108) to a stripping column for the removal of remaining hydrogen sulfide which exits by the top the tower (C) and improved crude which exits by the bottom (B) is sent to the storage tank.

Catalysts used in hydro treating heavy fractions are characterized by having a larger pore size than catalysts used in diesel and gasoline hydrodesulphurization, which, in general, are basically metal oxides partially or totally sulphurized for their activation. Hydrogenation, decarboxylation and decarboxylation process are carried out by active phases of the catalyst. The support of the catalyst provides a large superficial area, mechanical resistance and thermal stability, preventing sintering. This invention showed that there is a synergistic effect between metal sulfides of Mo (group VIB) and of Fe (group VIIIB) in reactions involved in the hydro treatment process. In such a way, the activity of catalysts containing sulfides of both groups is greater when compared to the activity of individual sulfides for the removal of naphthenic acids. Interaction of Fe—Mo active phase reduces deposition and disfavors unwanted reactions in the process. The catalyst used is FeMo supported on gamma alumina and/or Mg-alumina spinel. Different atomic relations of FeMo of the catalyst ranging between 0.05 and 1 were experimented. Optimal atomic relation of Fe to Mo found is 0.1 and molybdenum concentration in the catalyst ranges between 4-10% in molybdenum weight. Before processing crude, the catalyst was subject to an activation process with a 2% dimethyl disulfide mixture in diesel using hydrogen as gas to obtain molybdenum and Fe sulfide as active places in the catalyst.

Improved crude was physic-chemically characterized by the following methods: ASTM D1552 standard method for total sulfur; digital density at 288 K ASTM D4052; 353 K ASTM D445 standard test for kinematic viscosity; ASTM-664 standard test for acid number of petroleum products; 309 K-1013K-ASTMD7169 tests for simulated distillation at high temperatures for crudes; ICP-OES hydrocarbon quantitative analysis (Al, Ba, Ca, Cu, Fe, Mg, Mo, Ni, K, Na, V); UST-LAS-I-193-2012 determination and distribution of molecular weight. Gas resulting from the reaction was analyzed using the Gas Refinery Method (% weight)—UOP 539.

### 1. BRIEF DESCRIPTION OF THE FIGURES

FIG. 1 shows the general diagram of the invention process.

FIG. 2 shows the percentage of reduction of acidity and of removal of sulphur in the feed after the hydro treatment process with commercial catalysts versus the process performed using FeMo catalyst at conditions of temperature 623 K, 4.13 MPa and LHSV: 0.1 h−1.

FIG. 3 shows the percentage of acidity reduction and that of the removal of sulphur in the feed after the hydro treatment process with commercial catalysts versus the process performed using FeMo catalyst at temperature conditions of 623 K, 4.13 MPa and LHSV: 0.1 h−1 [sic].

FIG. 4 shows the comparison between the acidity reduction percentage in the product after the hydro treatment process with the FeMo/γ-alumina catalysts versus Mo/γ-alumina and Mo/Mg-alumina spinel at 573 K, 623 K, 4.13 MPa and LHSV: 0.1 h−1.

FIG. 5 shows the comparison between the sulphur removal percentage in the feed after the hydro treatment process with FeMo/γ-alumina catalysts versus the Mo/γ-alumina and Mo/Mg-alumina spinel at 573 K, 623 K, 4.13 MPa and LHSV: 0.1 h−1.

FIG. 6 shows the consumption of hydrogen for the different catalysts at operating temperature conditions of 573 K and 623 K, P: 4.13 MPa LHSV: 1.1 h−1.

FIG. 7 shows the distribution of molecular weight for naphthenic acids of crude before and after the hydro treatment process with FeMo at operating temperature conditions of 573 K, P: 4.13 MPa and LHSV: 1.1 h−1.

FIG. 8 shows the comparison of acidity reduction in terms of the feed after the hydro treatment process with basic catalysts such as MgO/γ-alumina (commercial) and CaO catalysts of 5 y 10% (supported on γ-alumina and boehmite).

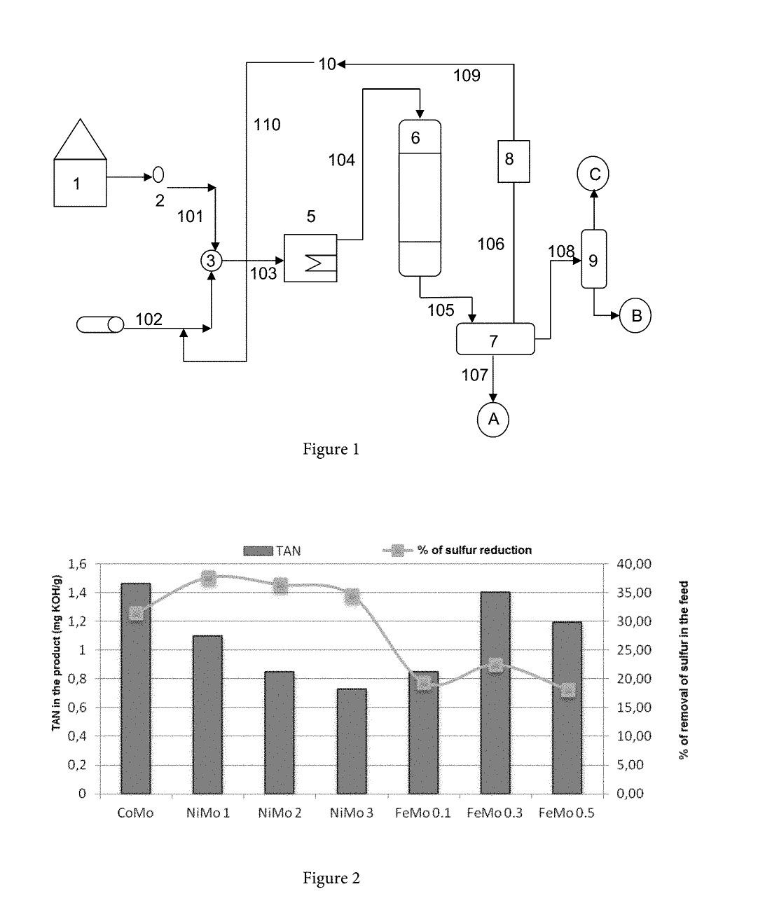

### 2. EXAMPLES

### Example 1

Results obtained through tests conducted with hydro treatment commercial catalysts such as CoMo, NiMo1, NiMo2, NiMo3 and Fe—Mo catalyst supported on alumina with a molybdenum concentration of 10% and a variation of the atomic ratio of Fe with respect to Mo between 0.1 and 0.5 are shown below. The Fe—Mo catalyst has a total area of 256 m²/g, pore volume of 0.63 cm³/g and pore diameter of 97.84 Å.

All of the catalysts were evaluated with heavy crude (Table 1) in a shaker tank reactor in presence of hydrogen and catalyst feed of 90 cm³; operating conditions for the hydro treatment were 573.15 K and 623.15 K at pressure of 4.13 MPa psi and LHSV of 1.1 h⁻¹.

TABLE 1
Feed characteristics: heavy crude

| Property | Method | Unit | Measure |
|---|---|---|---|
| Sulphur | ASTM D4294 | % Weight | 1.6 |
| Density | ASTM D 5002 | Kg/m3 | 989.2 |
| API gravity | ASTM D 5002 | °API | 11.4 |
| Acid number | ASTM D 664 | mg KOH/g | 7.113 |
| Kinematic viscosity 80° c. | ASTM D 445 | mm2/s | 251.5 |
| Water content | ASTM D 4377 | % peso | 1.62 |

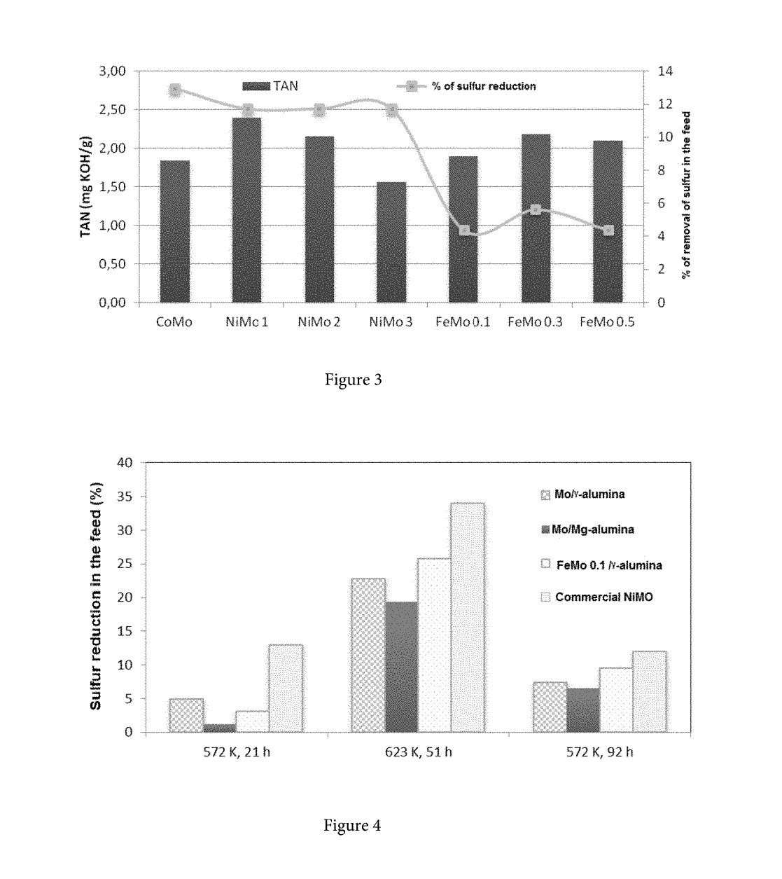

FIG. 2 and FIG. 3 show the comparison of the characteristics of enhanced crude with commercial catalysts versus the process performed using FeMO catalyst at different atomic ratios, at temperature conditions of 623.15 K, 4.13 MPa and LHSV: 0.1 h−1.

Experimental results show that commercial catalysts such as CoMo when compared to NiMO and FeMo catalysts have a lower selectivity to hydro deoxygenation reactions and a greater affinity to unwanted reactions such as hydrodesulphurization.

The FeMo catalyst in an atomic ratio lower that 0.3 shows a 75% reduction in Sulphur generation when compared to CoMo and NiMO commercial catalyst and a removal of acidity near 90%.

According to the above, the technology, using FeMo catalysts, allows technical and economic advantages given the longer useful life of the catalyst by the reduction in deposition of metal sulphides, lower consumption of hydrogen and without the likelihood of needing to consider a Sulphur treatment plant.

A similar behavior is observed in FIG. 3 when the hydro treatment process is performed at 573.15 K after 90 hours of operation, where a lower removal of Sulphur compounds takes place with FeMo catalysts and there is a greater removal when using commercial catalysts, thus keeping a similar removal of naphthenic acids with both catalysts.

Finally, it is worth noting that although Fe belongs to group VIIIB of the periodic table when processing heavy crudes with acidity greater than 4 mg KOH/g it shows a different behavior than that of Ni and Co in terms of desulphurization reactions.

### Example 2

FeMo and Mo catalysts supported in alumina and Mg-aluminum spinel were evaluated at pilot scale, aimed at analyzing the contribution of the Fe and that of the support in the hydro deoxygenation process. A CSTR reactor with a 90 cm3 loading catalyst was used for such tests, which was previously activated with dimethyl disulfide at 2% (v/v) under 593 K, LHSV: 1.1 h⁻¹ conditions and a hydrogen/dimethyl disulfide relation of 120 Nm3/m3.

Subsequently, each catalyst was fed with 7 mg KOH/g acidity crude, at two different temperature conditions: 573 K and 623 K at a pressure of 4.13 MPa, LHSV: 1.1 h−1 and at a volume flow of hydrogen of 0.014 Nm3/h. At the same time the stability of each catalyst was evaluated returning to the initial temperature condition of 573 K.

The textural characterization reported in Table 2 showed that the pore diameter varies from 90 Å to 115 Å, total area between 180 and 280 m²/g and the pore volume goes from 0.4 to 0.7 cm³/g. Based on gases adsorption measurements, the superficial area and the distribution of the pore sizes of the solid materials were determined, and the pore diameter was determined by the BJH method.

To prepare the catalysts, the starter was alumina, followed by an impregnation with Mg to obtain the spinel support and subsequently the Mo metal is impregnated. This catalyst is compared to the Mo/γ-alumina and the FeMo/γ-alumina.

Results are reported in Table 2 and such results demonstrate a reduction of the average diameter in the catalyst when the texture of the catalyst is modified with Mg and when there is an impregnation of Mo and Fe metals.

TABLE 2
Textural characterization of supports and catalysts

| | | | | | Total | External | Average | |
|---|---|---|---|---|---|---|---|---|
| | Metal content (% p) | | | | Area | Area | Diameter | Volume |
| CATALYST | Al | Mg | Mo | Fe | m2/g | m2/g | Å | cm³/g |
| γ-alumina(Support) | 44.85 | — | — | — | 262.41 | 258.88 | 109.79 | 0.72 |
| Mo/γ-alumina | 32.92 | — | 6.80 | — | 272.43 | 264.78 | 99.34 | 0.68 |
| Mo/spinel Mg-Alumina | 34.74 | 6.69 | 6.85 | — | 193.45 | 185.79 | 100.61 | 0.49 |
| FeMo 0.1/γ-alumina | 42.8 | — | 6.80 | 0.48 | 256.54 | 232.388 | 97.84 | 0.63 |

FIG. 4 shows the results obtained for each one of the catalysts in the different supports, demonstrating an improvement on acidity reduction by 7% and 4% at low temperatures, when the FeMo active phase is incorporated regarding the Mo/spinel Mg-alumina and Mo/γ-alumina catalyst, respectively.

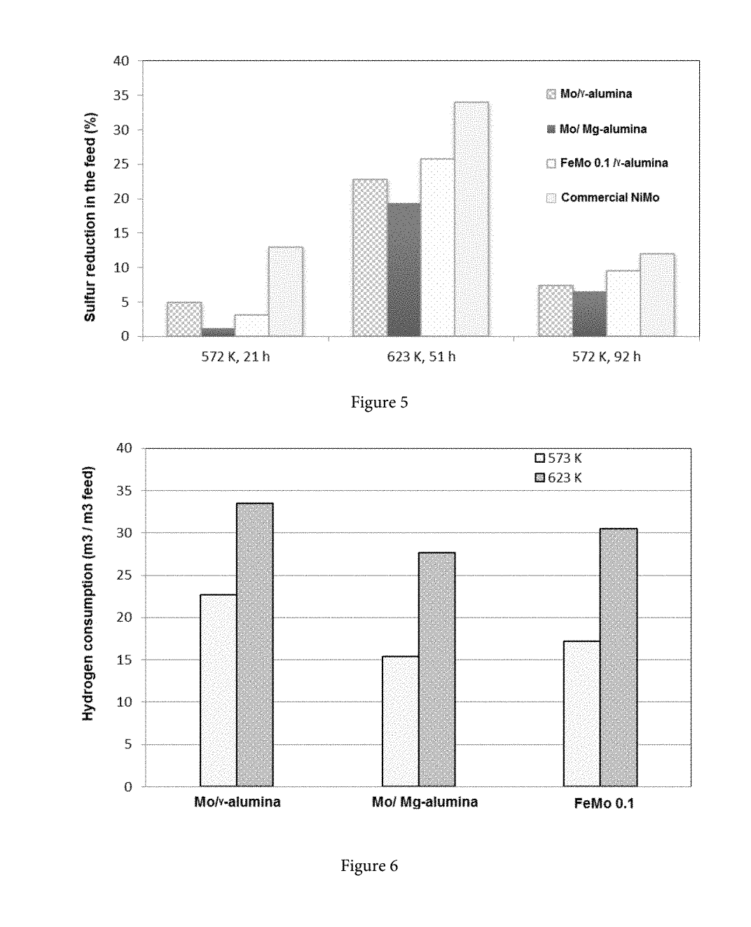

In terms of the sulfur reduction in the load, as shown in FIG. 5, at temperatures of 573K the benefit of the hydro de-sulphuraion reactions is lower for the Mo/spinel Mg-alumina, FeMo/γ-alumina catalysts. In larger severities there is a slight increase the FeMo catalyst when compared to others. However, the removal of sulphur compounds is lower than the results obtained with commercial catalysts.

According to the results it may be inferred that the Fe metal provides greater hydrogenating properties to the catalyst to favor hydro deoxygenation reactions in naphthenic acids with a lower removal of Sulphur components when compared to the Mo/alumina catalyst. On the other hand, it is observed that the spinel Mg-alumina support diminishes the removal of sulfurs in the load, most likely due to the occupation of the vacancies thus avoiding the deposition of sulfurs in the surface of the catalyst.

Finally, when comparing the three catalysts over time and temperature, it may be inferred that the catalysts are stable since they keep an acidity removal and a low production of Sulphur components.

In terms of hydrogen consumption, FIG. 6 shows that the acidity reduction process for the three catalysts presents a consumption lower than 35 Nm3/m3 of load, being the Mo/Mg-alumina the one that obtained a lower consumption: 15 Nm3/m3 and 28 Nm3/m3 of load at 573 K and 623 K, respectively.

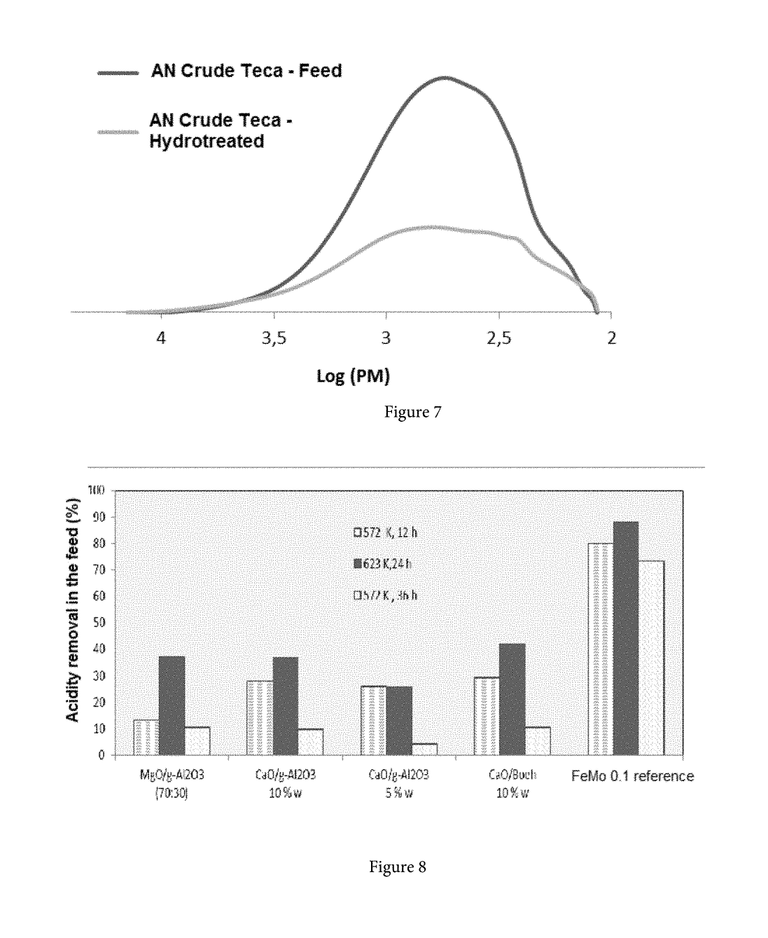

On the other hand, the logarithm distribution for the molecular weight was performed for both the acid and the enhanced crude with a FeMo/γ-alumina catalyst, as shown in FIG. 7. FIG. 7 shows that the removal of naphthenic acids is proportional throughout the distribution, which means that the catalyst is not selective to a determined molecular weight, but that it makes a conversion for all the molecular weights of naphthenic acids present in the crude, thus diminishing the effect of corrosion in all of the cuts of crude to be processed in the refineries.

Properties such as viscosity, water and density were measured for the load crude and the product obtained from the tests performed with the FeMo/γ-alumina catalyst. The results on Table 3 show a reduction of 23% in viscosity and an increase of one point in °API. These quality progresses are reflected in economic benefits due to the improvement in crude fluidity and to a smaller quantity of thinner used for transportation.

TABLE 3
Characterization of load and product of the crude
processed with FeMo/Y-alumina catalyst at 573.15 K

| | | | | Improved |
|---|---|---|---|---|
| | | | | Crude |
| | | | | FeMo/Y- |
| Characteristic | Method | Unit | Load | Alumina |
| Density | ASTM D 5002 | Kg/m³ | 983 | 972 |
| Gravity API | ASTM D 5002 | °API | 12.2 | 13.9 |
| Cinematic | ASTM D 445 | mm2/s | 183.7 | 140.7 |
| Viscosity 353 K | | | | |
| Water Content | ASTM D 4377 | % weight | 0.23 | 0.25 |

### Example 3

One of the most attractive methods to perform the removal of acidity is the decarboxylation of the naphthenic acids on basic catalysts. The adequate catalytic materials to carry out the reaction are composed by inorganic metals, specifically carbonates, basic carbonates and oxide of alkaline-earth metals (Be, Mg, Ca, Sr and Ba). Under such conditions, a set of experiments that included the comparison of the commercial MgO/γ-alumina and the CaO catalysts (supported in γ-alumina and bohemite) were conducted using different percentages of Ca to verify the selectivity in the process of removal of naphthenic acids.

All the catalysts were evaluated with heavy crude according to the characterization reported in Table 4, in a reactor of a shaken tank in presence of hydrogen with a 9 e-5 m³ of catalyst load. The operation conditions of hydro treatment were of 573 K and 623 K at a pressure of 4.13 MPa and LHSV of 1.1 h⁻¹.

FIG. 8 shows that the percentage of acidity removal in basic catalysts with a temperature of 623 K reaches a maximum removal of 36 and 42% for the 10% CaO catalysts supported in bohemite and alumina, respectively.

Experimental results showed that the decarboxylation and hydro deoxygenation reactions are favored when more severities are used in the process with 7 mg KOH/g acidity crudes. However, the activity of basic catalysts is not enough to obtain crude with acidity lower than 2 mg KOH/g as it is the case of the FeMo/γ-alumina catalyst where the acidity removals mount to 80% and the stability is higher as time goes by.

Table 4 shows that secondary reactions as the hydro desulfurization are not favored in the basic catalysts where sulfur removal in the 623 K load fluctuates between 1% and 3%, thus, that of the 10% CaO/bohemite catalyst being greater. On the other hand, it is evident that the CaO catalysts present lower stability as time goes by when compared to the MgO and FeMo catalysts, as a result, the useful life of the catalysts is expected to be less than the one reported in previous examples herein.

TABLE 4
Characteristics of the load and reaction product using basic catalysts at 350° C.

| | | VISCOSITY | | | DENSITY | |
|---|---|---|---|---|---|---|
| | Acid Number | AT 80° C. | SULFUR | N2 | AT 15° C. | GRAVITY |
| | (mg KOH/g) | (mm2/s) | (% P) | (% P) | (Kg/m3) | API |
| Acid Crude | 6.656 | 177.7 | 1.53 | 0.1645 | 984.8 | 12.2 |
| MgO/γ-alumina | 4.179 | 130.4 | 1.52 | 0.1596 | 982.5 | 12.4 |
| CaO/γ-alumina | 4.934 | 128.0 | 1.52 | 0.1558 | 982.1 | 12.5 |
| 10% | | | | | | |
| CaO/γ-alumina, | 4.195 | 124.1 | 1.50 | 0.1862 | 979.9 | 12.8 |
| 5% | | | | | | |
| CaO/bohemite, | 3.840 | 123.6 | 1.48 | 0.1737 | 980.1 | 12.8 |
| 10% | | | | | | |

### SUMMARY OF THE INVENTION

It is evident that the naphthenic acids present in the crude, are carboxylic acids, characterized for being an aliphatic ring (or several rings) or naphthenic with a corresponding alkyl group, which ends in a carboxylic acid group. Naphthenic acids produce atypical corrosion phenomena, since they are capable of producing a localized attack without any presence of water at temperatures between 473 K and 693 K thus hindering the processing of these types of crudes at refineries.

This invention describes a catalytic hydrogenation process that allows the selective removal of naphthenic acids in heavy and extra heavy crudes with a low production of hydrogen sulfides, specifically in crude not previously distilled into fractions. The catalyst is composed by an alumina and/or aluminum-magnesium type support with active Fe—Mo phases.

Additionally, the applicant has surprisingly found that the hydrogenation process using Fe and Mo catalysts and/or mixtures between them allows to reach acid numbers of 1 mg KOH/g in crudes with TAN greater than 4 mg KOH/g, thus achieving the reduction of unwanted reactions in the process thus extending the useful life of the catalyst as a result of the low deposition of metal sulphides.

1. A process for selective removal of naphthenic acids from heavy and extra heavy crude with low production of hydrogen sulfurs, through a catalytic hydrogenation process, comprising:
a) combining heavy crude directed from a storage tank with hydrogen directed from a line in a mixer;
b) directing a mixture from a current to a heating process in a furnace at a reaction temperature of 473 K to 673 K in the presence of a catalyst;
c) transporting the heated mixture to a reactor where hydro deoxygenation reactions take place at an average temperature of 523 K to 643 K, pressures of 0.6 to 7 MPa, spatial speed of 0.5 h⁻¹ to 2 h⁻¹ and a H₂/load relation of 53 to 300 m³ standard/m³ of load;
d) directing the hydro treated product from a bottom of the reactor to a separation system, wherein hydrogen and other light compounds are directed to the separation system through an upper part without reaction, directing water at the bottom and a third current to a backing off, and obtaining hydrogen sulfide from the top and enhanced crude from the bottom; and
e) processing the recovered hydrogen in a splitting system, purifying the hydrogen, compressing the hydrogen, and blending the hydrogen with fresh hydrogen before recirculating to the process.

2. The process of claim 1, wherein the reaction temperature of step b) is about 503 K-643 K.

3. The process of claim 1, wherein spatial speed is 0.5 to 1.5 h⁻¹.

4. The process of claim 1, wherein the pressure is about 0.6 to 6 MPa.

5. The process of claim 1, wherein the hydro deoxygenation reactions take place in the reactor in a relation of H₂/load of 53 to 200 m³ standard per m³ of load.

6. The process of claim 1, wherein the load to be processed is a crude with API gravity of 5-20 without suffering any previous fractioning processes.

7. The process of claim 1, wherein the acid number of the crude is 2 to 15 mg KOH/g of crude.

8. The process of claim 1, wherein the catalyst comprises at least one Mo or Fe metal or mixture thereof as active catalytic metals.

9. The process of claim 8, wherein the catalyst is FeMo supported in alumina gamma.

10. The process of claim 8, wherein the catalyst is FeMo supported in spinel of alumina-magnesium.

11. The process of claim 8, wherein the Fe has an atomic relation from of 0.05 to 0.3 in terms of molybdenum.

12. The process of claim 8, wherein the catalyst comprises Mo metal in an amount of 4-8% by weight in terms of the weight of the catalyst.

13. The process of claim 10, wherein the catalyst comprises Mg in an amount of 1 to 8% by weight in terms of the weight of the catalyst.

14. The process of claim 8, wherein the catalyst has an average pore diameter in the range of 90 to 200 Å.
